(19) United States
(12) Patent Application Publication
(10) Pub. No.: US 2026/0016703 A1
(43) Pub. Date: Jan. 15, 2026

(54) DISPLAY MODULES AND APPARATUSES FOR AERIAL SUSPENSION DISPLAY

(71) Applicant: WUHAN CHINA STAR OPTOELECTRONICS TECHNOLOGY CO., LTD., Wuhan (CN)

(72) Inventors: Guiyang ZHANG, Wuhan (CN); Rui HE, Wuhan (CN)

(73) Assignee: WUHAN CHINA STAR OPTOELECTRONICS TECHNOLOGY CO., LTD., Wuhan (CN)

(21) Appl. No.: 19/022,433

(22) Filed: Jan. 15, 2025

Related U.S. Application Data
(63) Continuation of application No. PCT/CN2024/105430, filed on Jul. 15, 2024.

(30) Foreign Application Priority Data
Jul. 9, 2024 (CN) 202410917231.2

(51) Int. Cl. G02B 30/56

(52) U.S. Cl. CPC G02B 30/56

(57) ABSTRACT

A display module includes a display panel, a negative refractive index plate and a light control member. The negative refractive index plate is arranged on a light exit side of the display panel, and configured to reflect first exit light from the display panel and guide the first exit light to exit from a light exit side of the negative refractive index plate as second exit light. The light control member is arranged on the light exit side of the negative refractive index plate and configured to intercept at least part of the second exit light subjected to an odd number of reflections by the negative refractive index plate.

### CROSS-REFERENCE TO RELATED APPLICATIONS

This application is a continuation of International Application No. PCT/CN2024/105430, filed on Jul. 15, 2024, which claims priority to Chinese Patent Application No. 202410917231.2, filed on Jul. 9, 2024. The disclosures of the abovementioned applications are incorporated herein by reference in their entireties.

### TECHNICAL FIELD

The present application relates to display technologies, and in particular to display modules and apparatuses for aerial suspension display.

### BACKGROUND

With the development of display technology, aerial suspension display technology has emerged. In this technology, it is necessary to use a reflection element to project a picture displayed on a display panel into the air, thereby realizing medium-free aerial suspension display. This technology is applicable to industries such as vehicles, advertising and educational equipment. Generally, various solutions for aerial suspension display may have respective disadvantages, such as picture blur, reduction in brightness, reduction in contrast, picture crosstalk and so on. For example, the solution for aerial suspension display using a negative refractive index plate (i.e., a plate having a negative refractive index) as the reflection element may have the problem of picture crosstalk.

### SUMMARY

According to some embodiments of the present application, a display module includes: a display panel; a negative refractive index plate arranged on a light exit side of the display panel, the negative refractive index plate being configured to reflect first exit light from the display panel and guide the first exit light to exit from a light exit side of the negative refractive index plate as second exit light; and a light control member arranged on the light exit side of the negative refractive index plate and configured to intercept at least part of the second exit light subjected to an odd number of reflections by the negative refractive index plate.

According to some embodiments of the present application, an apparatus for aerial suspension display includes the above display module.

### BRIEF DESCRIPTION OF THE DRAWINGS

FIG. 1 schematically illustrates the principle of using a negative refractive index plate for aerial suspension display.

FIG. 2 schematically illustrates the details of the negative refractive index plate in FIG. 1.

FIG. 3 schematically illustrates a light reflection path in part of the negative refractive index plate in FIG. 2.

FIG. 4 schematically illustrates an aerial suspended real picture and interference pictures formed by the negative refractive index plate in FIG. 2.

FIG. 5 schematically illustrates a structure of a display module according to some embodiments of the present application.

FIG. 6 schematically illustrates an aerial suspended real picture formed by the display module in FIG. 5.

FIG. 7 schematically illustrates a partial schematic diagram of a display module according to some embodiments of the present application.

FIG. 8 schematically illustrates another partial schematic diagram of a display module according to some embodiments of the present application.

FIG. 9 schematically illustrates yet another partial schematic diagram of a display module according to some embodiments of the present application.

FIG. 10 schematically illustrates yet another partial schematic diagram of a display module according to some embodiments of the present application.

FIG. 11 schematically illustrates yet another partial schematic diagram of a display module according to some embodiments of the present application.

### DETAILED DESCRIPTION

Some embodiments of the present application will be described in detail below with reference to the accompanying drawings. The embodiments are described for illustrative purposes only and are not intended to limit the present application.

Directional terms mentioned in the present application, such as “upper”, “lower”, “front”, “back”, “left”, “right”, “inner”, “outer” and “side” are for referring to the accompanying drawings only. Therefore, the directional terms used are to illustrate and describe, but not to limit, the present application. In the accompanying drawings, units with similar structures are represented by the same numbers. In the accompanying drawings, the thickness of some layers and regions has been exaggerated for clarity and ease of description. That is, the dimensions and thickness of each component shown in the accompanying drawings are shown arbitrarily, and will not be a limit of the present application.

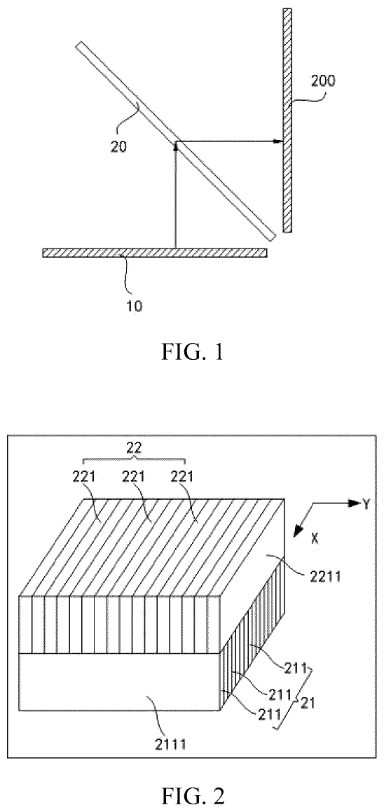

Referring to FIG. 1, a negative refractive index plate 20 is set on the light exit side of display panel 10. After passing through the negative refractive index plate 20, the first exit light from display panel 10 forms the suspended real picture 200 opposite to the display panel 10 on the light exit side of negative refractive index plate 20. The suspended real picture 200 is symmetrical with the display panel 10 about negative refractive index plate 20. Negative refractive index plate 20 is a kind of flat lens. The negative refractive index plate 20 includes an upper lens and a lower lens that are closely fitted and superimposed. The upper lens and the lower lens adopt a plurality of reflecting bars perpendicular to the surface of the lens and arranged in parallel, and each reflecting bar includes a substrate and reflecting films arranged on both sides of the substrate. The reflecting bars of the upper lens are arranged orthogonal with the reflecting bars of the lower lens.

Specifically, referring to FIG. 2, the negative refractive index plate 20 includes a first reflecting layer 21 and a second reflecting layer 22, and the first reflecting layer 21 includes a plurality of first reflecting bars 211 arranged along a first direction X, each first reflecting bar 211 includes two opposite first reflecting surfaces 2111, and the first direction X is perpendicular to the first reflecting surface 2111. The second reflecting layer 22 is located on the side of the first reflecting layer 21 away from the display panel 10, and the second reflecting layer 22 includes a plurality of second reflecting bars 221 arranged along the second direction Y, each second reflecting bar 221 includes two opposite second reflecting surfaces 2211, and the second reflecting surface 2211 is perpendicular to and intersects the first reflecting surface 2111. The second direction Y is perpendicular to the second reflecting surface 2211 and perpendicular to the first direction X. Each of the first reflecting bar 211 and the second reflecting bar 221 includes a substrate and reflecting films arranged on two opposite sides of the substrate. The substrate includes a transparent substrate such as a glass or resin film material. The reflecting film arranged on the substrate is the first reflecting surface 2111 or the second reflecting surface 2211. According to the light field reconstruction principle, the negative refractive index plate 20 re-converges the first exit light, emitted by display panel 10, on one side of the negative refractive index plate 20 into a real picture in air at another side of the display panel 10.

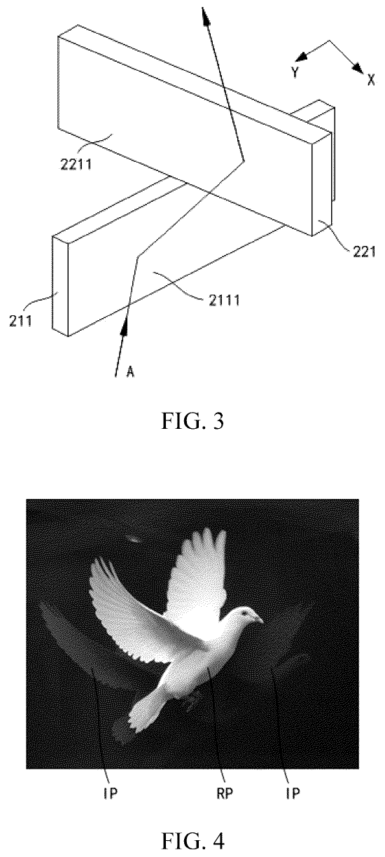

Referring to FIG. 3, the first exit light emitted by the display panel 10 forms a suspended real picture in the air after two reflections of the negative refractive index plate 20. For example, the first light A in the first exit light emitted by the display panel 10 is illustrated as an example, the first light A is first reflected by the first reflecting surface 2111 of the first reflecting bar 211, and then reflected by the second reflecting surface 2211 of the second reflecting bar 221, and then exits from the exit side of the negative refractive index plate 20 as the second exit light after being reflected by the second reflecting bar 221. The second exit light forms a suspended real picture in the air. However, when the first exit light emitted by the display panel 10 passes through the negative refractive index plate 20, in addition to twice reflection, there would be a zero reflection, a once reflection, a three times reflection, a four times reflection, etc.

It should be noted that the zero reflection means that the first exit light emitted by the display panel 10 directly exits from the negative refractive index plate 20, and is not reflected by the negative refractive index plate 20; the once reflection means that the first exit light emitted by the display panel 10 is reflected once on the first reflecting layer 21 or the second reflecting layer 22 of the negative refractive index plate 20; twice reflection means that the first exit light emitted by the display panel 10 is reflected once on each of the first reflecting layer 21 and the second reflecting lay 22 of the negative refractive index plate 20; the three times reflection means that the first exit light emitted by the display panel 10 is reflected three times in total on the first reflecting layer 21 and the second reflecting layer 22 of the negative refractive index plate 20; the four times reflection means that the first exit light emitted by the display panel 10 is reflected twice on each of the first reflecting layer 21 and the second reflecting layer 22 of the negative refractive index plate 20. Among these reflections, the reflected light of twice reflection is the effective light that forms the aerial suspended real picture, and the reflected lights of zero reflection, once reflection, three times reflection, four times reflection, etc., is the crosstalk light of forming the aerial suspended real picture.

Referring to FIG. 4, the reflected light of twice reflection, as an effective light for forming aerial suspended real picture, can restore the picture on the display panel 10 to form in the air a real picture RP corresponding to the picture on the display panel 10, and the crosstalk light formed by reflected lights of zero reflection, once reflection, three times reflection, four times reflection, etc., will form an interference picture IP in the air. The interference picture IP is located around the real picture RP, resulting more serious picture crosstalk of large angle. Moreover, the presence of the interference picture IP on one hand increases the display background brightness and reduces the picture contrast, on the other hand, it also affects the display effect, and there are multi-shadow problems leading to vertigo and so on.

In view of the above, a display module according to some embodiments of the present application includes:

a display panel;

a negative refractive index plate arranged on a light exit side of the display panel, the negative refractive index plate being configured to reflect first exit light from the display panel and guide the first exit light to exit from a light exit side of the negative refractive index plate as second exit light; and

a light control member arranged on a light exit side of the negative refractive index plate and configured to intercept at least part of the second exit light which is subjected to an odd number of reflections by the negative refractive index plate.

In some embodiments, the negative refractive index plate includes:

a first reflecting layer, the first reflecting layer includes a plurality of first reflecting bars arranged along a first direction, each of the plurality of first reflecting bars includes two opposite first reflecting surfaces, and the first direction is perpendicular to the first reflecting surface;

a second reflecting layer, the second reflecting layer is located on a side of the first reflecting layer away from the display panel, and the second reflecting layer includes a plurality of second reflecting bars arranged along a second direction, each of the plurality of second reflecting bars includes two opposite second reflecting surfaces, and the second reflecting surface is perpendicular to and intersects the first reflecting surface, the second direction is perpendicular to the second reflecting surface and perpendicular to the first direction.

The light control member is arranged on a side of the second reflecting layer away from the first reflecting layer.

In some embodiments, the first exit light from the display panel includes a circularly polarized light, and the light control member includes a circular polarizer, the handedness of the circular polarizer is the same as that of the circularly polarized light.

In some embodiments, the circularly polarized light is left-handed circularly polarized light, the circular polarizer is left-handed circular polarizer.

In some embodiments, the circularly polarized light is right-handed circularly polarized light, the circular polarizer is right-handed circular polarizer.

In some embodiments, the circular polarizer includes a quarter-wave plate and a linear polarizer which are stacked.

In some embodiments, the first exit light from the display panel includes a linearly polarized light, and the light control member includes a linear polarizer;

the display module further includes a light adjustment member, the light adjustment member is arranged between, any one or a combination of, adjacent first reflecting bars and adjacent second reflecting bars, and the light adjustment member is configured to change the polarization direction of the linearly polarized light in conjunction with the negative refractive index plate.

In some embodiments, the light adjustment member includes a quarter-wave plate.

In some embodiments, the polarization direction of the linear polarizer is perpendicular to the polarization direction of the linearly polarized light; and the light adjustment member is arranged between adjacent first reflecting bars or between adjacent second reflecting bars.

In some embodiments, the linear polarizer is a horizontal polarizer, and the linearly polarized light is a vertically polarized light; the light adjustment member is arranged between adjacent second reflecting bars.

In some embodiments, the linear polarizer is a vertical polarizer, and the linearly polarized light is a horizontally polarized light; the light adjustment member is arranged between adjacent second reflecting bars.

In some embodiments, the linear polarizer is a horizontal polarizer, and the linearly polarized light is a vertically polarized light; the light adjustment member is arranged between adjacent first reflecting bars.

In some embodiments, the linear polarizer is a vertical polarizer, and the linearly polarized light is a horizontally polarized light; the light adjustment member is arranged between adjacent first reflecting bars.

In some embodiments, the polarization direction of the linear polarizer is same with the polarization direction of the linearly polarized light; and the light adjustment member is arranged between adjacent first reflecting bars and between adjacent second reflecting bars.

In some embodiments, the linear polarizer is a vertical polarizer, and the linearly polarized light is a vertically polarized light.

In some embodiments, the linear polarizer is a horizontal polarizer, and the linearly polarized light is a horizontally polarized light.

In some embodiments, the negative refractive index plate is tilted relative to the display panel, and the inclination angle between the negative refractive index plate and the display panel ranges from 10 to 50 degrees.

In some embodiments, the display panel includes a light-emitting diode display panel, a liquid crystal display panel, a liquid crystal on silicon display panel, an organic light-emitting diode display panel, a micro light-emitting diode display panel, a mini light-emitting diode display panel, a projection display panel, a laser display panel or a laser diode display panel.

In some embodiments, the present application further provides an apparatus for aerial suspension display, the apparatus for aerial suspension display includes the display module described in one of the above embodiments.

In the display module and the suspension display apparatus provided in the present application, the display module includes a display panel, a negative refractive index plate and a light control member, the negative refractive index plate is configured to reflect the first exit light from the display panel and guide the first exit light to exit from the light exit side of the negative refractive index plate as the second exit light; the light control member is arranged on the light exit side of the negative refractive index plate, and the light control member is configured to intercept at least part of the second exit light which is subjected to an odd number of reflections by the negative refractive index plate, in order to reduce the crosstalk light affecting the aerial imaging effect, improve the technical problem of picture crosstalk in an solution for aerial suspension display using a negative refractive index plate as a reflecting element.

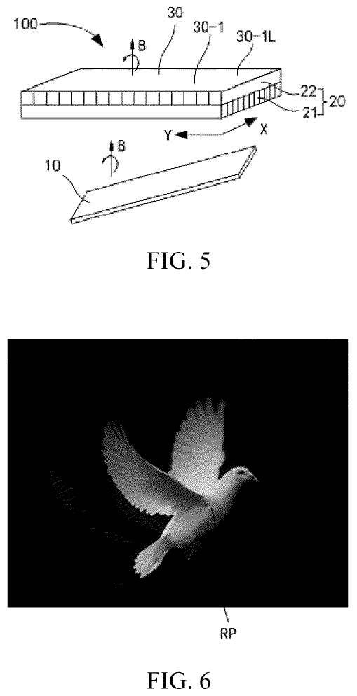

FIG. 5 shows a structural diagram of a display module according to some embodiments of the present application. FIG. 6 shows a schematic diagram of an aerial suspended real picture formed by the display module in FIG. 5.

Referring to FIG. 5, the display module 100 includes a display panel 10, a negative refractive index plate 20 and a light control member 30. The negative refractive index plate 20 is arranged on the light exit side of the display panel 10, and is configured to reflect the first exit light from the display panel 10 and guide the first exit light to exit from the light exit side of the negative refractive index plate 10 as the second exit light. The light control member 30 is arranged on the light exit side of the negative refractive index plate 20, and the light control member 30 is configured to intercept at least part of the second exit light which is subjected to an odd number of reflections by the negative refractive index plate 20, in order to reduce the crosstalk light affecting the aerial imaging effect, improve the technical problem of picture crosstalk in an solution for aerial suspension display using the negative refractive index plate 20 as a reflecting element.

Specifically, the negative refractive index plate 20 includes a first reflecting layer 21 and a second reflecting layer 22. The first reflecting layer 21 includes a plurality of first reflecting bars 211 arranged along a first direction X, each first reflecting bar 211 includes two opposite first reflecting surfaces 2111, and the first direction X is perpendicular to the first reflecting surface 2111. The second reflecting layer 22 is located on the side of the first reflecting layer 21 away from the display panel 10, and the second reflecting layer 22 includes a plurality of second reflecting bars 221 arranged along the second direction Y, each second reflecting bar 221 includes two opposite second reflecting surfaces 2211, and the second reflecting surface 2211 is perpendicular to and intersects the first reflecting surface 2111, the second direction Y is perpendicular to the second reflecting surface 2211 and perpendicular to the first direction X. The light control member 30 is located on the side of the second reflecting layer 22 away from the first reflecting layer 21.

Optionally, the display panel 10 may be a light-emitting diode (LED) display panel, a liquid crystal display (LCD) panel, a liquid crystal on silicon (LCOS) display panel, an organic light-emitting diode (OLED) display panel, a micro light-emitting diode (Micro-LED) display panel, a mini light-emitting diode (Mini-LED) display panel, a projection display panel, a laser display panel, a laser diode display panel, or any other suitable display panel.

In some embodiments, the first exit light from the display panel 10 includes a circularly polarized light, and accordingly, the light control member 30 includes a circular polarizer 30-1, and the handedness of the circular polarizer 30-1 is the same as that of the circularly polarized light. The circular polarizer 30-1 includes a quarter-wave plate (QWP) and a linear polarizer which are stacked. The circular polarizer 30-1 is capable of passing through a circularly polarized light with the same handedness and intercepting a circularly polarized light with the opposite handedness.

Optionally, as shown in FIG. 5, the circularly polarized light is left-handed circularly polarized light B, and the circular polarizer 30-1 is left-handed circular polarizer 30-1L. The left-handed circular polarizer 30-1L is capable of passing through the left-handed circularly polarized light B while intercepting circularly polarized light of the other handedness. When the left-handed circularly polarized light B emitted by the display panel 10 passes through the negative refractive index plate 20, it will be reflected and occurs zero reflection, once reflection, three times reflection, four times reflection, etc. Wherein, the left-handed circularly polarized light B will change the handedness after odd times reflections and become right-handed circularly polarized light, and will not change the handedness after even times reflections and remain left-handed circularly polarized light, such as the left-handed circularly polarized light B, which will become right-handed circularly polarized light after once reflection, or three times reflection of the negative refractive index plate 20, and the left-handed circularly polarized light B is still left-handed circularly polarized light after the twice reflection of the negative refractive index plate 20. Thus, in the left-handed circularly polarized lights B emitted by the display panel 10, the left-handed circularly polarized light B will become right-handed circularly polarized light after odd times reflection such as once reflection, or three times reflection of the negative refractive index plate 20, and the right-handed circularly polarized light cannot pass through the left-handed circular polarizer 30-1L. The left-handed circular polarizer 30-1L can intercept the second exit light of the left-handed circularly polarized light B which is emitted by the display panel 10 and through odd times reflection of the negative refractive index plate 20, in order to reduce crosstalk light, improve the picture contrast, and thereby improve the technical problem of picture crosstalk in a solution for aerial suspension display using the negative refractive index plate 20 as a reflecting element.

In some other embodiments, the circularly polarized light is right-handed circularly polarized light, and the circular polarizer 30-1 is right-handed circular polarizer. The right-handed circular polarizer is capable of passing through the right-handed circularly polarized light while intercepting circularly polarized light of the other handedness. When the right-handed circularly polarized light emitted by the display panel 10 passes through the negative refractive index plate 20, it will be reflected and occurs zero reflection, once reflection, three times reflection, four times reflection, etc. Wherein, the right-handed circularly polarized light will change the handedness after odd times reflection and become left-handed circularly polarized light, and will not change the handedness after even times reflections and remain right-handed circularly polarized light, such as the right-handed circularly polarized light, which will become left-handed circularly polarized light after once reflection, or three times reflection of the negative refractive index plate 20, and the right-handed circularly polarized light is still right-handed circularly polarized light after the twice reflection of the negative refractive index plate 20. Thus, in the right-handed circularly polarized lights emitted by the display panel 10, the right-handed circularly polarized light will become left-handed circularly polarized light after odd times reflection such as once reflection, or three times reflection of the negative refractive index plate 20, and the left-handed circularly polarized light cannot pass through the right-handed circular polarizer. The left-handed circular polarizer can intercept the second exit light of the right-handed circularly polarized light which is emitted by the display panel 10 and through odd times reflection of the negative refractive index plate 20, in order to reduce crosstalk light, improve the picture contrast, and thereby improve the technical problem of picture crosstalk in a solution for aerial suspension display using the negative refractive index plate 20 as a reflecting element.

Referring to FIG. 6, compared with FIG. 4, it can be seen that by configuring the light control member 30 on the light exit side of the negative refractive index plate 20, the light control member 30 can intercept the second exit light through odd times reflection of the negative refractive index plate 20, and thereby reduce the crosstalk picture formed by the second exit light reflected by the odd times, and force the dark area of the aerial suspended picture formed by the display module 100 to be darker and the contrast of the picture to be improved; the reduction of the crosstalk picture can also improve the vertigo caused by the multi-shadow problem and improve the display effect.

In some embodiments, as shown in FIG. 5, the negative refractive index plate 20 is tilted relative to the display panel 10, and the inclination angle between the negative refractive index plate 20 and the display panel 10 ranges from 10 to 50 degrees to reduce the second exit light of the first exit light from the display panel 10 through zero reflection of the negative refractive index plate 20, and to further improve the picture crosstalk problem.

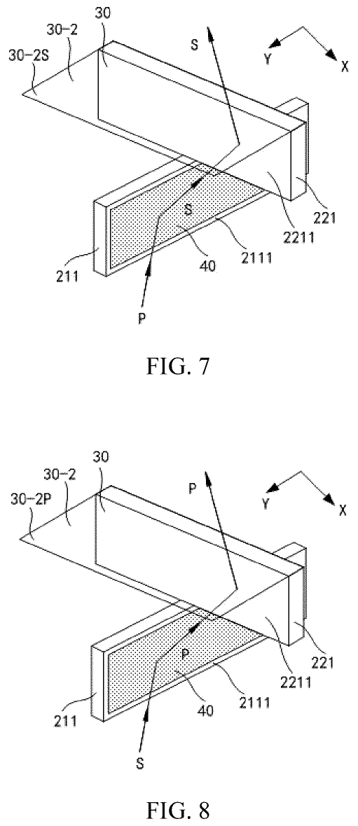

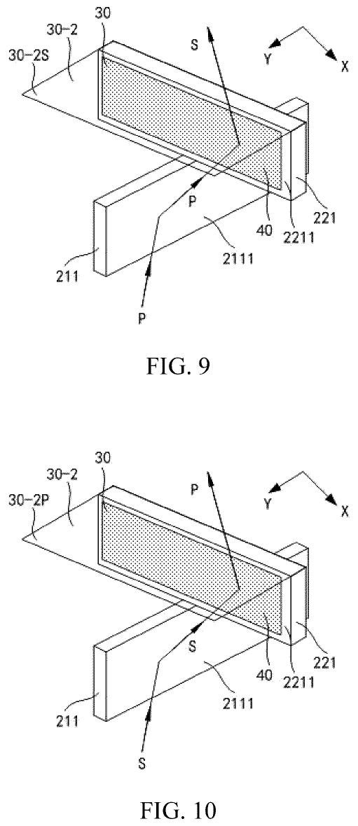

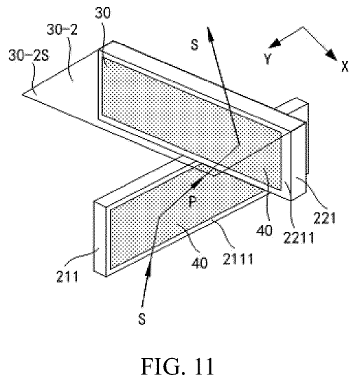

FIG. 7 shows a partial schematic diagram of a display module according to some embodiments of the present application. FIG. 8 shows another partial schematic diagram of a display module according to some embodiments of the present application. FIG. 9 shows another partial schematic diagram of a display module according to some embodiments of the present application. FIG. 10 shows another partial schematic diagram of a display module according to some embodiments of the present application. FIG. 11 shows another partial schematic diagram of a display module according to some embodiments of the present application.

Referring to FIG. 7 to FIG. 11, unlike the embodiments shown in FIG. 5, the first exit light from the display panel 10 includes linearly polarized light, and the light control member 30 includes a linear polarizer 30-2, and linear polarizer 30-2 is capable of passing through the linearly polarized light with the same polarization direction and intercepting linearly polarized light with different polarization direction. the display module 100 further includes a light adjustment member 40, the light adjustment member 40 is arranged between, any one or a combination of, adjacent first reflecting bars 211 and adjacent second reflecting bars 221, and the light adjustment member 40 is configured to change the polarization direction of the linearly polarized light in conjunction with the negative refractive index plate 20. Optionally, the light adjustment member 40 includes a quarter-wave plate. The same parts as the above embodiments are not repeated here, and the differences with the above embodiments are specified below.

In some embodiments, referring to FIG. 7, the polarization direction of the linear polarizer 30-2 is perpendicular to the polarization direction of the linearly polarized light. The light adjustment member 40 is arranged between the adjacent first reflecting bars 211, for example, the light adjustment member 40 may be arranged on the first reflecting surface 2111 of the first reflecting bar 211. Optionally, at least one of the first reflecting bar 211 is arranged between the two adjacent light adjustment members 40 so that the light adjustment members 40 are evenly distributed in the first reflecting layer 21 to achieve the purpose of better light adjustment. Optionally, the linearly polarized light is the horizontally polarized light P, and the linear polarizer 30-2 is the vertical polarizer 30-2S. When the horizontally polarized light P emitted by the display panel 10 passes through the negative refractive index plate 20, it will be reflected and occurs zero reflection, once reflection, three times reflection, four times reflection, etc.

For the horizontally polarized light P, the second exit light of which is still the horizontally polarized light P after zero reflection of the negative refractive index plate 20, and the horizontally polarized light P will be intercepted by the vertical polarizer 30-2S when passing through the vertical polarizer 30-2S. That is, the vertical polarizer 30-2S can intercept the second exit light of the horizontally polarized light P through zero reflection of the negative refractive index plate 20, and further reduce the crosstalk picture formed by the reflected light of zero reflection.

There are two situations for the second exit light of the horizontally polarized light P through once reflection of the negative refractive index plate 20, one is that the reflection occurs on the first reflecting surfaces 2111, at this time, since a light adjustment member 40 is arranged on the first reflecting surfaces 2111, the horizontally polarized light P passes through the light adjustment member 40 to the first reflecting surfaces 2111, and passes through the light adjustment member 40 again after being reflected by the first reflecting surfaces 2111, then the horizontally polarized light P is transformed, with change of polarization direction, into vertically polarized light S, the vertically polarized light S can pass through the vertical polarizer 30-2S; the second is that the reflection occurs on the second reflecting surfaces 2211, at this time, since no light adjustment member 40 is arranged on the second reflecting surfaces 2211, the horizontally polarized light P is directly reflected by the second reflecting surfaces 2211, maintaining the horizontally polarized light P, and the vertical polarizer 30-2S can intercept the horizontally polarized light P. Thus, by arranging the light adjustment member 40 between the adjacent first reflecting bars 211 and in conjunction with the light control member 30, half of the reflected light of once reflection can be intercepted, so as to reduce the crosstalk picture formed by the reflected light of once reflection.

For the second exit light of the horizontally polarized light P through twice reflection of the negative refractive index plate 20, taking the horizontally polarized light P is firstly reflected by the first reflecting surface 2111 and secondly reflected by the second reflecting plate as an example, the horizontally polarized light P passes through the light adjustment member 40 to the first reflecting surfaces 2111, and passes through the light adjustment member 40 again after being reflected by the first reflecting surfaces 2111, the horizontally polarized light P is transformed, with change of polarization direction, into vertically polarized light S at this time. The vertically polarized light S is then reflected by the second reflecting plate, and maintains the vertically polarized light S after being reflected by the second reflecting plate, the vertical polarized light S can pass through the vertical polarizer 30-2S. Similarly, when the horizontally polarized light P is first reflected by the second reflecting surface 2211 and then by the first reflecting plate, the second exit light after twice reflection can also pass through the vertical polarizer 30-2S. Thus, by arranging the light adjustment member 40 between the adjacent first reflecting bars 211 and in conjunction with the light control member 30, the reflected light of twice reflection will not be intercepted.

There are two situations for the second exit light of the horizontally polarized light P through three times reflection of the negative refractive index plate 20, one is that the reflection occurs twice on the first reflecting surfaces 2111 and once on the second reflecting surface 2211, in particular, since the light adjustment member 40 is arranged on the first reflecting surface 2111, the horizontally polarized light P is transformed into the vertically polarized light S after being reflected by the first reflecting surface 2111 for the first time, and the vertically polarized light S is still the vertically polarized light S after being reflected by the second reflecting surface 2211. After being reflected by the first reflecting surface 2111 for the second time, the vertically polarized light S is transformed into the horizontally polarized light P, and the horizontally polarized light P is intercepted by the vertical polarizer 30-2S; the second is that the reflection occurs once on the first reflecting surfaces 2111 and twice on the second reflecting surface 2211, in particular, the horizontally polarized light P is still the horizontally polarized light P after being reflected by the second reflecting surface 2211 for the first time, the horizontally polarized light P is transformed into the vertically polarized light S after being reflected by the first reflecting surface 2111, and the vertically polarized light S is still the vertically polarized light S after being reflected by the second reflecting surface 2211 for the second time, the vertically polarized light S can pass through the vertical polarizer 30-2S. Thus, by arranging the light adjustment member 40 between the adjacent first reflecting bars 211 and in conjunction with the light control member 30, half of the reflected light of three times reflection can be intercepted, so as to reduce the crosstalk picture formed by the reflected light of three times reflection.

For the second exit light of the horizontally polarized light P through four times reflection of the negative refractive index plate 20, taking the horizontally polarized light P is firstly reflected by the first reflecting surface 2111 and secondly reflected by the second reflecting 2211 as an example, since the light adjustment member 40 is arranged on the first reflecting surface 2111, the horizontally polarized light P is transformed into the vertically polarized light S after being reflected by the first reflecting surface 2111 for the first time, and the vertically polarized light S is still the vertically polarized light S after being reflected by the second reflecting surface 2211 for the first time. After being reflected by the first reflecting surface 2111 for the second time, the vertically polarized light S is transformed into the horizontally polarized light P, and the horizontally polarized light P is still the horizontally polarized light P after being reflected by the second reflecting surface 2211 for the second time, and the horizontally polarized light P is intercepted by the vertical polarizer 30-2S. Thus, by arranging the light adjustment member 40 between the adjacent first reflecting bars 211 and in conjunction with the light control member 30, the reflected light of four times reflection can be intercepted, so as to reduce the crosstalk picture formed by the reflected light of four times reflection.

In summary, by arranging the light adjustment members 40 between the adjacent first reflecting bars 211 and in conjunction with the light control member 30, it is capable of intercepting the reflected lights of zero reflection, four times reflection, and half of the reflected lights of once reflection, three times reflection, that is, the reflected lights of zero reflection, part of the reflected lights of odd times reflection, part of the reflected lights of even times reflection could be intercepted, thus the crosstalk picture formed by the reflected light of zero reflection, odd times reflection and part of the reflected light of even times reflection could be reduced. Moreover, it can be seen from the second exit light which is capable of passing through the vertical polarizer 30-2S that the number of times that this part of the second exit lights pass through the light adjustment member 40 is equal to 2*(2n+1), where n=0, 1, 2, 3 or any other non-negative integer.

In some embodiments, referring to FIG. 8, different from the embodiment shown in FIG. 7, the linearly polarized light is vertically polarized light S, and the linear polarizer 30-2 is horizontal polarizer 30-2P. At this time, it is also capable of intercepting the reflected light of zero reflection, part of the reflected light of odd times reflection and part of the reflected light of even times reflection, thus the crosstalk picture formed by the reflected light of zero reflection, odd times reflection and part of the reflected light of even times reflection could be reduced. For other descriptions, please refer to the above embodiments.

In some embodiments, referring to FIG. 9, the light adjustment member 40 is arranged between the adjacent second reflecting bars 221, for example, the light adjustment member 40 may be arranged on the second reflecting surface 2211 of the second reflecting bar 221, which is different from the embodiment shown in FIG. 7. Optionally, at least one of the second reflecting bar 221 is arranged between the two adjacent light adjustment members 40 so that the light adjustment members 40 are evenly distributed in the second reflecting layer 22 to achieve the purpose of better light adjustment. In this embodiment, it is also capable of intercepting the reflected light of zero reflection, part of the reflected light of odd times reflection and part of the reflected light of even times reflection, thus the crosstalk picture formed by the reflected light of zero reflection, odd times reflection and part of the reflected light of even times reflection could be reduced. For other descriptions, please refer to the above embodiments.

In some embodiments, referring to FIG. 10, different from the embodiment shown in FIG. 9, the linearly polarized light is vertically polarized light S, and the linear polarizer 30-2 is horizontal polarizer 30-2P. At this time, it is also capable of intercepting the reflected light of zero reflection, part of the reflected light of odd times reflection and part of the reflected light of even times reflection, thus the crosstalk picture formed by the reflected light of zero reflection, odd times reflection and part of the reflected light of even times reflection could be reduced. For other descriptions, please refer to the above embodiments.

In some embodiments, referring to FIG. 11, different from the embodiment shown in FIG. 10, the polarization direction of the linear polarizer 30-2 is same as the polarization direction of the linearly polarized light. The light adjustment members 40 are arranged between the adjacent first reflecting bars 211 and between the adjacent second reflecting bars 221, for example, the light adjustment members 40 may be arranged on the first reflecting surface 2111 of the first reflecting bar 211 and on the second reflecting surface 2211 of the second reflecting bar 221. Optionally, at least one of the first reflecting bar 211 is arranged between the two adjacent light adjustment members 40 on the first reflecting layer 21 so that the light adjustment members 40 are evenly distributed in the first reflecting layer 21, at least one of the second reflecting bar 221 is arranged between the two adjacent light adjustment members 40 on the second reflecting layer 22 so that the light adjustment members 40 are evenly distributed in the second reflecting layer 22, so as to achieve the purpose of better light adjustment.

Optionally, referring to FIG. 11, the linearly polarized light is vertically polarized light S, and the linear polarizer 30-2 is vertical polarizer 30-2P. When the vertically polarized light S emitted by the display panel 10 passes through the negative refractive index plate 20, it will be reflected and occurs zero reflection, once reflection, three times reflection, four times reflection, etc.

There are two situations for the second exit light of the vertically polarized light S through once reflection of the negative refractive index plate 20, one is that the reflection occurs on the first reflecting surfaces 2111, since the light adjustment member 40 is arranged on the first reflecting surface 2111 at this time, the vertically polarized light S passes through the light adjustment member 40 to the first reflecting surface 2111, and then passes through the light adjustment member 40 again after being reflected by the first reflecting surface 2111. Now the vertically polarized light S is transformed, with change of polarization direction, into the horizontally polarized light P, and the horizontally polarized light P is intercepted by the vertical polarizer 30-2S; the second is that the reflection occurs on the second reflecting surfaces 2211, since the light adjustment member 40 is arranged on the second reflecting surface 2211 at this time, after being reflected by the second reflecting surface 2211, the vertically polarized light S is transformed, with change of polarization direction, into the horizontally polarized light P, and the horizontally polarized light P is intercepted by the vertical polarizer 30-2S. Thus, by arranging the light adjustment members 40 between the adjacent first reflecting bars 211 and between the adjacent second reflecting bars 221, and in conjunction with the light control member 30, all the reflected light of once reflection can be intercepted, so as to reduce the crosstalk picture formed by the reflected light of once reflection.

For the second exit light of the vertically polarized light S through twice reflection of the negative refractive index plate 20, taking the vertically polarized light S firstly being reflected on the first reflecting surface 2111 and secondly being reflected on the second reflecting plate as an example, the vertically polarized light S passes through the light adjustment member 40 to the first reflecting surfaces 2111, and passes through the light adjustment member 40 again after being reflected by the first reflecting surfaces 2111, the vertically polarized light S is transformed, with change of polarization direction, into the horizontally polarized light P. After being reflected by the second reflecting plate, the horizontally polarized light P is transformed into the vertically polarized light S, the vertical polarized light S can pass through the vertical polarizer 30-2S. Similarly, when the vertical polarized light S is firstly reflected by the second reflecting surface 2211 and secondly by the first reflecting plate, the second exit light can also pass through the vertical polarizer 30-2S after twice reflection. Thus, by arranging the light adjustment members 40 between the adjacent first reflecting bars 211 and between the adjacent second reflecting bars 221, and in conjunction with the light control member 30, the reflected light of twice reflection will not be intercepted.

There are two situations for the second exit light of the vertically polarized light S through three times reflection of the negative refractive index plate 20, one is that the reflection occurs twice on the first reflecting surfaces 2111 and once on the second reflecting surface 2211, in particular, since the light adjustment member 40 is arranged on the first reflecting surface 2111, the vertically polarized light S is transformed into the horizontally polarized light P after being reflected by the first reflecting surface 2111 for the first time, the horizontally polarized light P is transformed into the vertically polarized light S after being reflected by the second reflecting surface 2211, and the vertically polarized light S is transformed into the horizontally polarized light P after being reflected by the first reflecting surface 2111 for the second time, the horizontally polarized light P is intercepted by the vertical polarizer 30-2S; the second is that the reflection occurs once on the first reflecting surfaces 2111 and twice on the second reflecting surface 2211, in particular, the vertically polarized light S is transformed into the horizontally polarized light P after being reflected by the second reflecting surface 2211 for the first time, the horizontally polarized light P is transformed into the vertically polarized light S after being reflected by the first reflecting surface 2111, and the vertically polarized light S is transformed into the horizontally polarized light P after being reflected by the second reflecting surface 2211 for the second time, the horizontally polarized light P is intercepted by the vertical polarizer 30-2. Thus, by arranging the light adjustment members 40 between the adjacent first reflecting bars 211 and between the adjacent second reflecting bars 221, and in conjunction with the light control member 30, all of the reflected light of three times reflection will be intercepted, so as to reduce the crosstalk picture formed by the reflected light of three times reflection.

In summary, by arranging the light adjustment members 40 between the adjacent first reflecting bars 211 and between the adjacent second reflector bars 221, and in conjunction with the light control member 30, it is capable of intercepting all reflected lights of zero reflection and three times reflection, that is, all reflected lights of odd times reflection could be intercepted, thus the crosstalk picture formed by the reflected light of odd times reflection could be reduced. For other descriptions, please refer to the above embodiments.

According to some embodiments of the present application, an apparatus for aerial suspension display includes any display module as described above.

In the above embodiments, the description of each embodiment has its own emphasis. For the parts not detailed in any embodiment, please refer to the related descriptions of other embodiments.

Some embodiments of the present application have been described in detail above. The description of the above embodiments merely aims to help to understand the present application. Many modifications or equivalent substitutions with respect to the embodiments may occur to those of ordinary skill in the art based on the present application. Thus, these modifications or equivalent substitutions shall fall within the scope of the present application.

What is claimed is:

1. A display module, comprising:
a display panel;
a negative refractive index plate arranged on a light exit side of the display panel, the negative refractive index plate being configured to reflect first exit light from the display panel and guide the first exit light to exit from a light exit side of the negative refractive index plate as second exit light; and
a light control member arranged on the light exit side of the negative refractive index plate and configured to intercept at least part of the second exit light subjected to an odd number of reflections by the negative refractive index plate.

2. The display module according to claim 1, wherein the negative refractive index plate comprises:
a first reflecting layer comprising a plurality of first reflecting bars arranged along a first direction, wherein each of the plurality of first reflecting bars has two opposite first reflecting surfaces, and the first direction is perpendicular to each of the first reflecting surfaces; and
a second reflecting layer located on a side of the first reflecting layer away from the display panel, the second reflecting layer comprising a plurality of second reflecting bars arranged along a second direction, wherein each of the plurality of second reflecting bars has two opposite second reflecting surfaces, each of the second reflecting surfaces is perpendicular to and intersects each of the first reflecting surfaces, and the second direction is perpendicular to each of the second reflecting surfaces and perpendicular to the first direction, and
wherein the light control member is arranged on a side of the second reflecting layer away from the first reflecting layer.

3. The display module according to claim 2, wherein the first exit light from the display panel comprises circularly polarized light, and the light control member comprises a circular polarizer having a same handedness as the circularly polarized light.

4. The display module according to claim 3, wherein the circularly polarized light is left-handed circularly polarized light, and the circular polarizer is a left-handed circular polarizer.

5. The display module according to claim 3, wherein the circularly polarized light is right-handed circularly polarized light, and the circular polarizer is a right-handed circular polarizer.

6. The display module according to claim 3, wherein the circular polarizer comprises a quarter-wave plate and a linear polarizer which are stacked.

7. The display module according to claim 2, wherein the first exit light from the display panel comprises linearly polarized light, and the light control member comprises a linear polarizer;
the display module further comprises one or more light adjustment members;
one of the light adjustment members is arranged between every two adjacent ones of the first reflecting bars, or/and one of the light adjustment members is arranged between every two adjacent ones of the second reflecting bars; and
each of the light adjustment members is configured to cooperate with the negative refractive index plate to change a polarization direction of the linearly polarized light.

8. The display module according to claim 7, wherein each of the light adjustment members comprises a quarter-wave plate.

9. The display module according to claim 7, wherein a polarization direction of the linear polarizer is perpendicular to the polarization direction of the linearly polarized light; and
each of the light adjustment members is arranged between two adjacent ones of the first reflecting bars or between two adjacent ones of the second reflecting bars.

10. The display module according to claim 9, wherein the linear polarizer is a horizontal polarizer, and the linearly polarized light is vertically polarized light; and
each of the light adjustment members is arranged between two adjacent ones of the second reflecting bars.

11. The display module according to claim 9, wherein the linear polarizer is a vertical polarizer, and the linearly polarized light is horizontally polarized light; and
each of the light adjustment members is arranged between two adjacent ones of the second reflecting bars.

12. The display module according to claim 9, wherein the linear polarizer is a horizontal polarizer, and the linearly polarized light is vertically polarized light; and
each of the light adjustment members is arranged between two adjacent ones of the first reflecting bars.

13. The display module according to claim 9, wherein the linear polarizer is a vertical polarizer, and the linearly polarized light is horizontally polarized light; and
each of the light adjustment members is arranged between two adjacent ones of the first reflecting bars.

14. The display module according to claim 7, wherein the linear polarizer has a same polarization direction as the linearly polarized light; and
one of the light adjustment members is arranged between every two adjacent ones of the first reflecting bars, and one of the light adjustment members is arranged between every two adjacent ones of the second reflecting bars.

15. The display module according to claim 14, wherein the linear polarizer is a vertical polarizer, and the linearly polarized light is vertically polarized light.

16. The display module according to claim 14, wherein the linear polarizer is a horizontal polarizer, and the linearly polarized light is horizontally polarized light.

17. The display module according to claim 1, wherein the negative refractive index plate is tilted relative to the display panel by an angle of 10˜50 degrees.

18. The display module according to claim 1, wherein the display panel is one of a light-emitting diode (LED) display panel, a liquid crystal display (LCD) panel, a liquid crystal on silicon (LCOS) display panel, an organic light-emitting diode (OLED) display panel, a micro light-emitting diode (Micro-LED) display panel, a mini light-emitting diode (Mini-LED) display panel, a projection display panel, a laser display panel, and a laser diode display panel.

19. An apparatus for aerial suspension display, comprising a display module,
wherein the display module comprises:
a display panel;
a negative refractive index plate arranged on a light exit side of the display panel, the negative refractive index plate being configured to reflect first exit light from the display panel and guide the first exit light to exit from a light exit side of the negative refractive index plate as second exit light; and
a light control member arranged on the light exit side of the negative refractive index plate and configured to intercept at least part of the second exit light subjected to an odd number of reflections by the negative refractive index plate.

20. The apparatus according to claim 19, wherein the negative refractive index plate comprises:
a first reflecting layer comprising a plurality of first reflecting bars arranged along a first direction, wherein each of the plurality of first reflecting bars has two opposite first reflecting surfaces, and the first direction is perpendicular to each of the first reflecting surfaces; and
a second reflecting layer located on a side of the first reflecting layer away from the display panel, the second reflecting layer comprising a plurality of second reflecting bars arranged along a second direction, wherein each of the plurality of second reflecting bars has two opposite second reflecting surfaces, each of the second reflecting surfaces is perpendicular to and intersects each of the first reflecting surfaces, and the second direction is perpendicular to each of the second reflecting surfaces and perpendicular to the first direction, and
wherein the light control member is arranged on a side of the second reflecting layer away from the first reflecting layer.
